(19) United States
(12) Patent Application Publication
(10) Pub. No.: US 2012/0107552 A1
(43) Pub. Date: May 3, 2012

(54) Chip Attachment Layer Having Traverse-Aligned Conductive Filler Particles

(75) Inventor: John P. TELLKAMP, Rockwall, TX (US)

(73) Assignee: Texas Instruments Incorporated, Dallas, TX (US)

(21) Appl. No.: 12/938,511

(22) Filed: Nov. 3, 2010

(51) Int. Cl. B32B 5/16; B32B 38/00; B32B 7/00

(52) U.S. Cl. 428/119; 156/272.4; 977/742

(57) ABSTRACT

A method for conductively attaching a workpiece (110) onto a substrate (101). Spreading a layer of an adhesive polymeric compound (130) over the first surface (101a) of the substrate, the compound including a suspension of electrically and thermally conductive first particles (140) intermixed with a suspension of ferromagnetic surfactant-coated second particles (141). Applying an external magnetic field (401) to the layer, the field oriented normal to the first surface and capable of arraying the ferromagnetic particles in lines, and, by causality, aligning the conductive particles in chains normal to the first surface. Orienting the second surface (110a) of the workpiece parallel to the first substrate surface (101a) and bringing the aligned conductive particle chains (140) in contact with the first and second surfaces by pressing the workpiece onto the layer and piercing the chain ends to touch the first and second surfaces.

### FIELD OF THE INVENTION

The present invention is related in general to the field of semiconductor devices and processes, and more specifically to the structure and fabrication method of chip attachment layers with traverse-aligned conductive filler particles.

### DESCRIPTION OF RELATED ART

When semiconductor chips have to be attached to substrates or leadframes, it is common practice to use a layer of adhesive compound, such as an epoxy-based polymeric formulation, as a coupler between the chip and the substrate. The polymeric compound is usually a thermoset resin, applied to the chip attach pad of the substrate as a low-viscosity precursor to allow spreading of the compound over the attach pad. After the precursor resin is distributed, the chip is pressed onto the layer with a force sufficient to partially redistribute the adhesive by flowing and thus to ensure a uniform layer thickness across the whole chip area. Thereafter, the layer, together with the chip and the substrate, is subjected to elevated temperatures for a certain amount of time to activate a resin polymerization process, which hardens the compound and thus irreversibly couples chip and substrate together.

For electrical circuit operation as well as for removal of the operational heat, it is common practice to add to the adhesive compound filler particles, which are electrically and thermally conductive. The most frequently used filler particles are elongated silver flakes with a length between 1 and 10 μm and an approximately uniform distribution across the attach layer. To achieve good electrical and thermal conductivity, the filler loadings typically have to be high, usually more than 80 weight % of the attach compound.

### SUMMARY OF THE INVENTION

Applicant detected in microscopic analysis that during the phase of pressuring the chip onto the attach layer, the flowing adhesive resin causes the conductive filler particles throughout the layer to become horizontally oriented with respect to the chip/layer and substrate/layer interfaces. Applicant further found that the particles are wetted on all surfaces by the low-viscosity resin, inhibiting metal-to-metal contact by surface tension and thus decreasing the electrical conductivity. In addition, continuous resin-rich films are formed on both chip/layer and substrate/layer interfaces, further lowering the electrical conductivity of the attach layer. The drop in conductivity becomes particularly dominant with decreasing layer thickness even when the layers include more than 80 weight % filler loadings.

Applicant saw that the problem of mediocre electrical and thermal conductivity of adhesive resin layers can be solved by aligning the electrically and thermally conductive filler particles in chains normal to the chip/layer and substrate/layer interfaces and piercing the chains through the resin-rich films to achieve contact both with the chip and the substrate. The electrical and thermal conductivity can be dramatically improved even at filler fillings significantly lower than 80 weight %; the lower filler loading, in turn, improves the mechanical adhesion.

Applicant discovered that the alignment in the layer of the conductive filler particles can be achieved by a method wherein the suspended conductive particles are intermixed with a second kind of suspended filler particles comprising a ferromagnetic core coated by surfactants at less than 10 weight % loading.

After spreading the resin layer of sufficiently low viscosity over the substrate, an external magnetic field normal to the layer is applied, which arrays the suspended ferromagnetic particles normal to the layer with enough force to simultaneously steer and align the conductive particles in chains normal to the layer surfaces. The chip is then pressed onto the resin layer, piercing the tips of the conductive chains through the resin-rich films on the layer surfaces and achieving contact both with the chip and the substrate. Finally, the resin with the aligned conductive chains is hardened by polymerization.

It is a technical advantage that dependent on the viscosity of the resin and the strength of the magnetic field, the external magnetic field may be applied continuously for the duration of the step of pressing the chip onto the layer, or the field may be cycled. The magnetic field can be created by permanent magnets or by electromagnets; the permanent magnets may be mounted on the assembly transport, or may applied through the polymerization step.

It is another technical advantage that the chips may be provided with a backside metallization including nickel; the magnetic field of the nickel will increase the chip press-down force, further improving the filler alignment and pierce-through performance.

The preferred conductive filler particles include elongated silver flakes; alternatively, they may be carbon nano-tubes, or particles comprising an elongated magnetic metal core (for example, iron) surrounded by a film of high electrical and thermal conductivity (for example, silver).

A second effective filler type contains a magnetic core coated by surfactants. The preferred filler particles of the second kind have a core selected from a group including iron, magnetite, nickel, cobalt, and compounds thereof, and a surfactant selected from a group including tetramethylammonium hydroxide, phosphoric acid ester, and ethoxylated aliphatic acid. The second filler type need not be intrinsically conductive, but must have magnetic susceptibility so as to transfer the force of magnetic attraction to other particles which are then oriented in a favorable direction.

A third filler type comprises elongated magnetic particles, such as iron particles, which are effective in changing orientation.

### BRIEF DESCRIPTION OF THE DRAWINGS

FIG. 1 shows a schematic cross section of a workpiece attached to a substrate by an adhesive compound, which includes electrically and thermally conductive filler particles aligned in chains normal to, and in contact with, the workpiece and the substrate.

FIG. 2 represents the chemical composition of the tetramethylammonium cation and the hydroxide anion employed for the electrostatic repulsion as the surfactant used for the magnetite particle fillers in the adhesive attachment compound of the invention.

FIG. 3 (prior art) illustrates schematically the action of the surfactants around the magnetite particle fillers, preventing the particles from agglomerating.

FIG. 4 illustrates schematically a fabrication method according to the invention, wherein a workpiece is attached to a substrate by an adhesive compound while an external magnetic field is applied. Suspended in the compound are chains of first particles, which are electrically and thermally conductive, and second particles, which are magnetized by the magnetic flux.

### DETAILED DESCRIPTION OF THE PREFERRED EMBODIMENTS

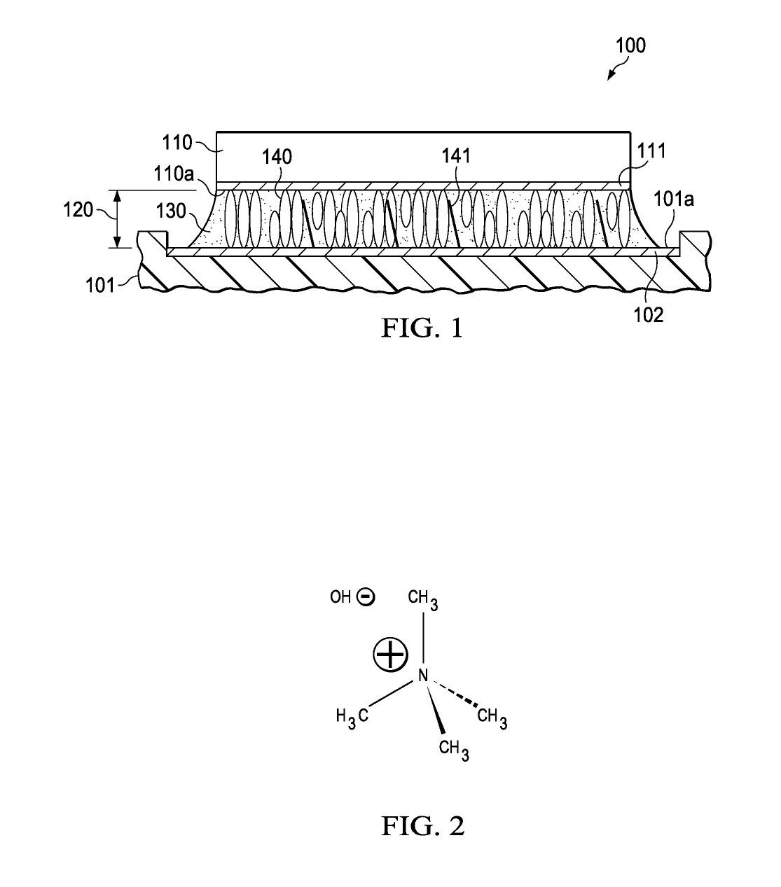

In a schematic cross section, FIG. 1 illustrates an exemplary device generally designated 100 assembled with an embodiment of the invention. Device 100 includes a substrate 101 and a workpiece 110. Substrate 101 may be an insulator, such as an FR-4 board, or a metal, such as a leadframe pad. Substrate 101 has a first surface 101a, which may be insulating or metallic, dependent on the material of the substrate. Preferably, surface 101a has good electrical and thermal conductivity; as sown in FIG. 1, an otherwise insulating substrate may have a metal inset 102 so that first surface 101a is actually the surface of the metal pad.

Workpiece 110 may be a semiconductor chip or any other piece part to be assembled on substrate 101. In either case, workpiece 110 may have a metal layer 111; for reasons of the invention to be discussed later (ferromagnetism), a preferred metal for layer 111 is nickel. Workpiece 110 has a second surface 110a. If workpiece 110 has metal layer 111, second surface 110a is actually the surface of the metal layer. Second surface 110a is parallel to first surface 101a and is spaced from the first surface by gap 120. Dependent on device 100, the width of gap 120 may vary from 100 μm or more to 4 μm or less.

As FIG. 1 shows, gap 120 is filled with an adhesive polymeric compound 130. A preferred compound is a thermoset compound, such as an epoxy-based formulation, which is polymerized. The compound adheres to first surface 101a and to second surface 110a and includes first particles 140 and second particles 141. Preferably, less than 10% of all particles belong to the second particles and the remainder (more than 90% of all particles) belongs to the first particles. First particles 140 are electrically and thermally conductive and are herein referred to as “conductive” particles. Preferably, first particles 140 include elongated flakes of silver or a silver alloy, the majority of the flakes having a length between about 1 and 10 μm. Alternatively, the conductive particles may include a core of magnetic metal, such as iron or nickel, surrounded by a film of electrically and thermally conductive metal, such as silver. As yet another alternative, the conductive particles may be carbon nanotubes. As FIG. 1 indicates schematically, first particles 140 are aligned in chains, which are substantially normal (i.e., vertical) to the first surface 101a and the second surface 110a. The conductive filler particles are, therefore, aligned in chains which traverse the plane defined by the layer.

As FIG. 1 further indicates, a plurality of the chain ends of the conductive particles is in contact with first surface 101a and second surface 110a. As an example, the sum of the electrical and thermal contacts of the chains to first surface 101a comprises at least 10% of the area of surface 101a, while the remaining 90% or less of the surface involves the adhesion between compound 130 and substrate 101.

The second particles 141 include a ferromagnetic core coated by surfactants so that the second particles can be magnetized and suspended in compound 130. The second particles have an outer diameter of about 20 to 30 nm and an inner core of about 10 to 15 nm diameter. The core may be selected from a group including iron, magnetite, nickel, cobalt, and compounds thereof. The surfactant may be selected from a group including tetramethylammonium hydroxide, phosphoric acid ester, and ethoxylated aliphatic acid. The second filler type need not be intrinsically conductive, but must have magnetic susceptibility so as to transfer the force of magnetic attraction to other particles which are then oriented in a favorable direction. When the second particles are magnetized, neighboring second particles are arrayed in lines approximately normal to the first surface 101a and second surface 110a.

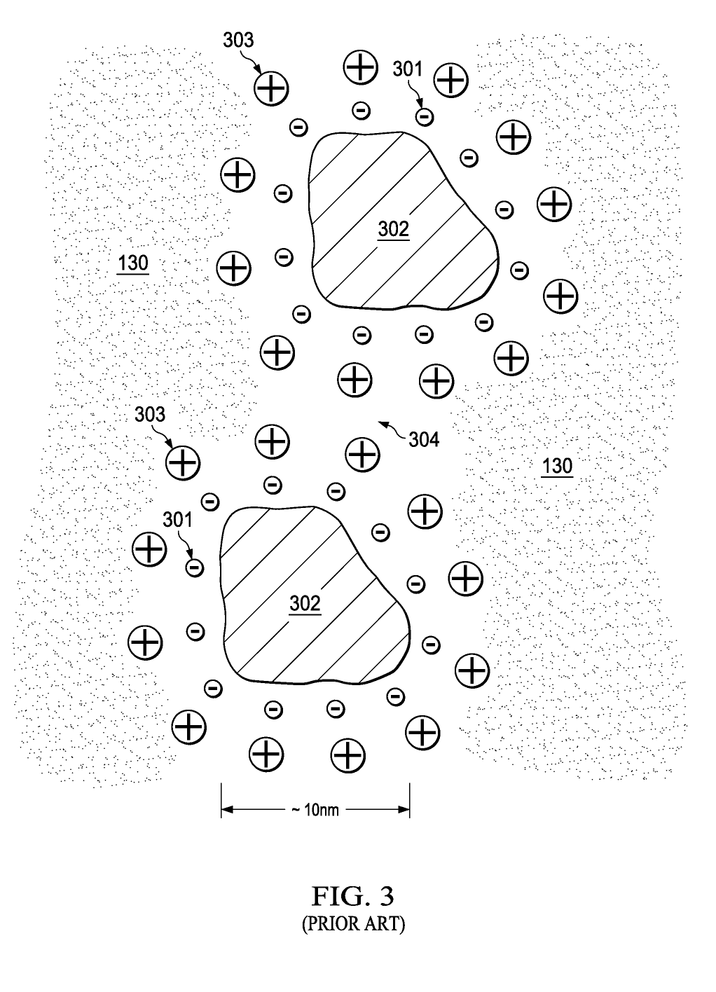

In order to describe an example of a surfactant, FIG. 2 depicts tetramethylammonium hydroxide with the molecular formula C₄H₁₃NO or (CH₃)₄NOH as two charged species, an anion (negative charge, OH—) and a cation (positive charge, (CH₃)₄N⁺). FIG. 3 illustrates the tetramethylammonium hydroxide used as a surfactant for a ferromagnetic core such as magnetite. The negatively charged hydroxide anions 301 adhere to the surface of magnetite particles 302, and these negative charges attract their positively charged counter ions, tetramethylammonium cations 303, to form a positively charged outer shell, or coat. Since like charges repel, the electrostatic interparticle repulsion between positively charged outer coats 304 prevent magnetite particles from agglomerating. Consequently, a colloidal suspension of magnetite nanoparticles (diameter approximately 10 nm or less) is formed in the matrix of the polymer compound 130. As mentioned, other examples of second particles 141 include a dispersion of oleic acid-coated magnetite nanoparticles using surfactants of phosphoric acid ester of an ethoxylated aliphatic acid.

Since ferromagnetic materials respond to external magnetic fields by aligning their unpaired electron spins with the external vector fields, dominating the forces of surface tension and gravity, the magnetite nanoparticles align, or spike, in the direction of the magnetic field lines; the stronger the vector field lines (and the lower the viscosity of the compound), the more forceful the alignment and larger the spikes, provided that the viscosity of the polymer compound is sufficiently low to facilitate the alignment.

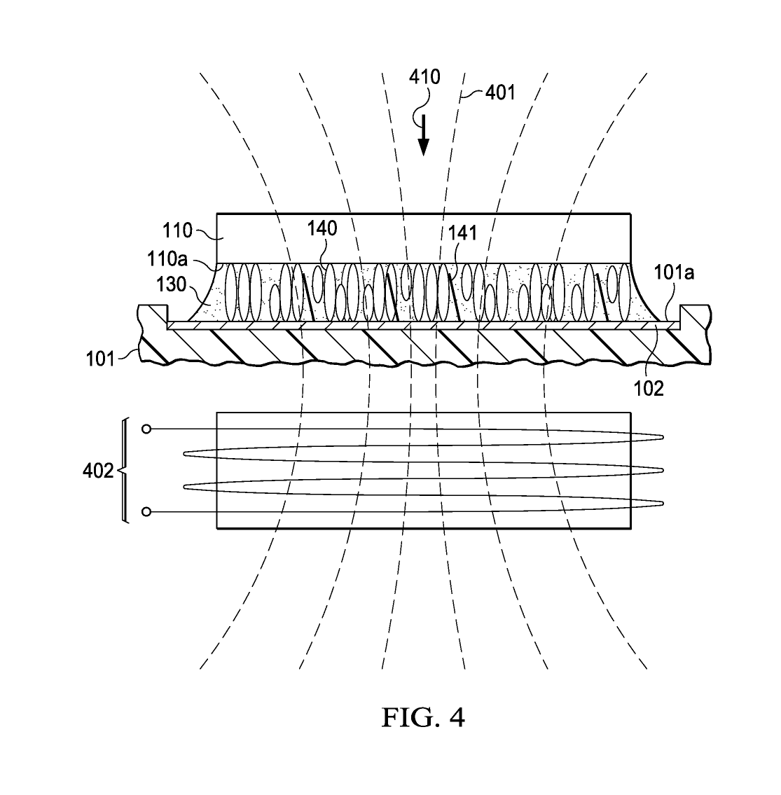

Another embodiment of the invention is a method of attaching a workpiece 110 onto a substrate 101 using an adhesive compound 130 with conductive filler particles. Certain conditions of the method are illustrated in FIG. 4. Substrate 101 may be made of an insulating or composite material, such as a glass fiber-strengthened board, or it may be a piece of metal such as the pad of a leadframe, for instance a copper-based leadframe. Alternatively, substrate 101 may have a metallic pad 102 on an insulating carrier 101 as shown in FIG. 4. Substrate 101 has a first surface 101a.

In the first step of the method, a predetermined amount of an adhesive polymeric compound is deposited on surface 101a. The compound is preferably an epoxy-based thermoset low-viscosity precursor. A preferred method is by letting a certain amount of the compound drop onto surface 101a from the orifice of a syringe. The compound may spread by surface tension over at least a portion of surface 101a to form an approximate layer, potentially with irregular outline and non-uniform thickness. The compound includes intermixed suspensions of two kinds of filler particles: The first particles have good electrical and thermal conductivity and are preferably made of silver flakes between about 1 and 10 μm length. In the suspension of the first particles, the length of the particles is oriented in random fashion, and the concentration of the first particles is preferably less than 90 weight % of the compound. Alternative to pure silver, the first particles may include a core of ferromagnetic metal such as iron or nickel, surrounded by a film of high-conductivity metal such as silver. As yet another alternative, the first particles may be carbon nanotubes.

The second particles are ferromagnetic and preferably made of a core of about 10 nm diameter of a ferromagnetic compound, where the core is coated with a surfactant to prevent the second particles from agglomerating; the outer diameter of the second particles is preferably between about 20 and 30 nm. In the suspension of the second particles, the concentration of the second particles is preferably less than 10 weight percent of the compound. The ferromagnetic core is selected from a group including iron, nickel, cobalt, and compounds thereof such as magnetite Fe₃O₄, and the surfactant coating is selected from a group including tetramethylammonium hydroxide, phosphoric acid ester, and ethoxylated aliphatic acid.

In the next step, an external magnetic vector force field is applied to the layer of polymeric compound with the suspensions of particles. As FIG. 4 illustrates, the magnetic field lines 401 are oriented about normal to the plane of the polymeric compound layer 130 on the first surface 101a of the substrate 101. In short expression, the magnetic field is oriented about normal, i.e. vertical, to the first surface 101a. The ferromagnetic cores of the second particles suspended in the polymeric layer respond to the external magnetic field by aligning their unpaired electron spins with the vector field. The magnetic field has a strength so that the magnetic force is large enough to dominate the forces of surface tension and gravity of the second particles and thus cause the second particles to form spikes in the direction of the magnetic field lines, since the stronger the vector field lines, the larger the spikes. In FIG. 4, the spikes are indicated by the orientation of the aligned second particles 141 substantially in the direction of the magnetic field lines 401.

In addition, the strength of the magnetic field is powerful enough to cause, along with the alignment of the magnetic second particles 141, the concurrent steering and aligning of the conductive first particles 140 in chains so that the chains of the first particles become oriented normal, i.e., vertical, to the first surface 101a. As FIG. 4 indicates, the needed strength of the magnetic field can be created by an electromagnet 402 with an iron core, or by a permanent magnet. The magnets are preferably positioned underneath substrate 101 in close proximity to the substrate. As an example, the magnets could be mounted in the workpiece mounter transport; in this position, the magnets could align the particles in the resin as the resin is dispensed and also during the workpiece placement. Alternatively, a magnetic strip carrier could be built to hold the strip until after the polymerization step if needed. To achieve the effective alignment of the second and first particles for a specific polymeric compound, the electromagnet may be turned on constantly for a given length of time, or may be activated with intermissions.

In the next process step, a workpiece 110 with a second surface 110a is provided; as an example, workpiece 110 may be a semiconductor integrated circuit chip and the second surface 110a may be the chip surface remote from the integrated circuit; surface 110a may have a layer of ferromagnetic metal such as nickel (not shown in FIG. 4). Second surface 110a is then oriented parallel to first surface 101a and brought into contact with the resin precursor layer.

While the magnetic field is continuously applied and first particles 140 are oriented normal (i.e., vertical) to substrate surface 101a, a mechanical force in the direction towards substrate 101, indicated by arrow 410 in FIG. 4, is applied to workpiece 110. This force presses workpiece 110 against the resin layer 130 on substrate 101 and its vertically oriented chains of first particles 140. The magnitude of the compressive force is selected to cause the chain tips of particles 140 to pierce the resin-rich boundary regions of layer 130 and, consequently, to touch both the workpiece surface 110a and the substrate surface 101a. Conductive electrical as well as thermal connections between workpiece 110 and substrate 101 are thus established directly through the insulating polymeric compound layer 130.

As has been mentioned above, the strength of the magnetic field can be enhanced by providing a ferromagnetic metal layer over surface 110a of the workpiece (such layer 111 is shown in FIG. 1, but not in FIG. 4). A preferred metal for this layer is nickel in a thickness range from about 10 to 25 μm.

It is advantageous for most devices 100 to harden compound 130 by polymerizing the thermoset precursor, preferably while the external magnetic field remains applied. The orientation of the conductive chains of particles 130 is thus frozen in the direction normal to the workpiece and to the substrate.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. As an example, the viscosity of the polymeric precursor is variable over a wide range; further the strength of the magnetic field is variable over a wide range. Consequently, the time of applying the external magnetic field may for some combinations of precursor and field strength be shortened so that the field is no longer applied during polymerization.

As an another example, since a relatively small percent of magnetite fillers is sufficient to align other, high-conductivity filler particles in the preferred orientation, carbon nanotubes may be used instead of the silver flakes as the high-conductivity fillers. Because of the high electrical and thermal conductivity of carbon nanotubes, the filler percentage may then be reduced to values substantially below 80 weight %. In turn, based on the lower filler loadings, more attachment area becomes available for improved mechanical adhesion of the polymeric compound to the substrate and the workpiece.

It is therefore intended that the appended claims encompass any such modifications or embodiments.

1. An apparatus comprising:
a substrate having a first surface;
a workpiece having a second surface parallel to the first surface and spaced from the first surface by a gap; and
a polymeric compound filling the gap and adhering to the first and second surfaces, the compound including electrically and thermally conductive particles aligned in chains normal to, and in contact with, the first and second surfaces.

2. The apparatus of claim 1 wherein the particles are metallic silver.

3. The apparatus of claim 1 wherein the particles include a core of ferromagnetic metal surrounded by a film of non-magnetic high-conductivity metal.

4. The apparatus of claim 3 wherein the particle ferromagnetic core includes iron or nickel and the high-conductivity metal film includes silver.

5. The apparatus of claim 1 wherein the particles are carbon nanotubes.

6. The apparatus of claim 1 wherein the polymeric compound is a polymerized thermoset compound.

7. The apparatus of claim 1 wherein the sum of the electrical and thermal contacts of the chains to the first surface comprises at least 10% of the surface area, while the remaining less than 90% of the surface involves the adhesion between compound and substrate.

8. The apparatus of claim 1 wherein the width of the gap is between about 4 and 200 μm.

9. The apparatus of claim 1 wherein the first and the second surface are electrically conductive.

10. An apparatus comprising:
a substrate having a first surface;
a workpiece having a second surface parallel to the first surface and spaced from the first surface by a gap; and
a polymeric compound filling the gap and adhering to the first and second surfaces, the compound including first and second particles;
the first particles being electrically and thermally conductive and aligned in chains normal to, and in contact with, the first and second surfaces; and
the second particles being suspended in the compound and susceptible to magnetization, neighboring second particles arrayed in lines normal to the first and second surfaces.

11. The apparatus of claim 10 wherein the second particles include a ferromagnetic metal core coated by surfactants.

12. The apparatus of claim 11 wherein the core is selected from a group including iron, magnetite, nickel, cobalt, and compounds thereof, and the surfactant is selected from a group including tetramethylammonium hydroxide, phosphoric acid ester, and ethoxylated aliphatic acid.

13. A method for conductively attaching a workpiece onto a substrate comprising the steps of:
forcing into chains the conductive first filler particles suspended in a polymeric layer adhering to a substrate by aligning, in an external magnetic field, ferromagnetic second filler particles suspended in the layer; and
bringing the conductive filler chains in contact with the substrate and a workpiece by pressing the workpiece onto the polymeric layer and piercing the chain ends to touch the substrate and the workpiece.

14. A method for conductively attaching a workpiece onto a substrate comprising the steps of:
spreading a layer of an adhesive polymeric compound over a substrate having a first surface, the compound including a suspension of electrically and thermally conductive first particles intermixed with a suspension of ferromagnetic surfactant-coated second particles;
applying an external magnetic field to the layer, the field oriented normal to the first surface and capable of arraying the ferromagnetic particles in lines, and, by causality, aligning the conductive particles in chains normal to the first surface;
providing a workpiece having a second surface parallel to the first surface; and
bringing the aligned conductive particle chains in contact with the first and second surfaces by pressing the workpiece onto the layer and piercing the chain ends to touch the first and second surfaces.

15. The method of claim 14 wherein the polymeric compound is a thermoset formulation of low viscosity.

16. The method of claim 15 further including, after the step if bringing in contact, the step of hardening the compound by polymerization.

17. The method of claim 14 wherein the conductive particles are selected from a group including elongated silver flakes, particles having a ferromagnetic core coated with a high-conductivity metal, and carbon nano-tubes.

18. The method of claim 17 wherein the conductive particles are less than 80 weight percent of the compound.

19. The method of claim 14 wherein the ferromagnetic particles are selected from a group including iron, magnetite, nickel, cobalt, and compounds thereof, and the surfactant coating is selected from a group including tetramethylammonium hydroxide, phosphoric acid ester, and ethoxylated aliphatic acid.

20. The method of claim 19 wherein the ferromagnetic particles are less than 10 weight percent of the compound.

21. The method of claim 14 further including, for the time duration of the step of bringing in contact, the step of concurrently applying the external magnetic field.
